(19) United States
(12) Patent Application Publication
(10) Pub. No.: US 2026/0360581 A1
(43) Pub. Date: Nov. 12, 2026

(54) HAZARDOUS WASTE REPOSITORY SYSTEMS AND METHODS

(71) Applicant: Deep Isolation, Inc., Berkeley, CA (US)

(72) Inventors: Richard A. Muller, Berkeley, CA (US); Elizabeth Muller, Berkeley, CA (US)

(21) Appl. No.: 19/125,811

(22) PCT Filed: Nov. 7, 2023
(86) PCT No.: PCT/US2023/078919

§ 371 Date: Apr. 30, 2025

Related U.S. Application Data
(60) Provisional application No. 63/423,202, filed on Nov. 7, 2022.
(60) Provisional application No. 63/423,207, filed on Nov. 7, 2022.

(51) Int. Cl. G21F 9/34; B09B 1/00; E21B 41/00

(52) U.S. Cl. CPC G21F 9/34; B09B 1/008; E21B 41/005

(57) ABSTRACT

A hazardous waste repository system includes a borehole repository that includes at least one human-unoccupiable borehole formed from a terranean surface into a subterranean formation suitable to store hazardous waste, where the at least one borehole includes an entry on a parcel of real property at the terranean surface and at least one human-unoccupiable storage region configured to store one or more hazardous waste canisters that enclose portions of a nuclear waste material. The system includes at least one of: (i) a nuclear waste facility, located on the parcel, that stores the nuclear waste material, or (ii) a nuclear power plant, located on the parcel, that produces the nuclear waste material.

### TECHNICAL FIELD

This disclosure relates to the permanent or temporary disposal of hazardous waste, such as radioactive or nuclear waste.

### BACKGROUND

Hazardous waste is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even military waste) is considered to be one of the outstanding challenges of energy technology. Safe storage of the long-lived radioactive waste is a major impediment to the adoption of nuclear power in the United States and around the world.

### SUMMARY

In a first example implementation, a hazardous waste repository system includes a borehole repository that includes at least one human-unoccupiable borehole formed from a terranean surface into a subterranean formation suitable to store hazardous waste, where the at least one borehole includes an entry on a parcel of real property at the terranean surface and at least one human-unoccupiable storage region configured to store one or more hazardous waste canisters that enclose portions of a nuclear waste material. The system includes at least one of: (i) a nuclear waste facility, located on the parcel, that stores the nuclear waste material, or (ii) a nuclear power plant, located on the parcel, that produces the nuclear waste material.

In an aspect combinable with the first example implementation, the at least one of (i) or (ii) includes both (i) and (ii).

In another aspect combinable with any of the previous aspects of the first example implementation, the at least one human-unoccupiable borehole includes a directional borehole, a vertical borehole, a slant borehole, or a combination thereof.

In another aspect combinable with any of the previous aspects of the first example implementation, the subterranean formation is at a depth below the terranean surface unsuitable for human occupation.

In another aspect combinable with any of the previous aspects of the first example implementation, the nuclear waste material includes remote handled nuclear waste.

In another aspect combinable with any of the previous aspects of the first example implementation, the nuclear waste material includes contact handled nuclear waste.

In another aspect combinable with any of the previous aspects of the first example implementation, the nuclear waste material includes remote handled nuclear waste.

In another aspect combinable with any of the previous aspects of the first example implementation, the nuclear waste material includes spent nuclear fuel.

In another aspect combinable with any of the previous aspects of the first example implementation, the subterranean formation includes salt, shale, sedimentary, igneous, or metamorphic rock.

In another aspect combinable with any of the previous aspects of the first example implementation, the at least one borehole includes a casing that lines at least a portion thereof.

In another aspect combinable with any of the previous aspects of the first example implementation, the at least one borehole includes a first borehole portion that includes a first portion of the human-unoccupiable storage region formed in the first subterranean formation; and a second borehole portion that includes a second portion of the human-unoccupiable storage region formed in a second subterranean formation.

In another aspect combinable with any of the previous aspects of the first example implementation, at least one of the first or second borehole portions is a horizontal borehole portion.

In another aspect combinable with any of the previous aspects of the first example implementation, the at least one borehole includes a seal positioned between the terranean surface and the human-unoccupiable storage region.

In a second example implementation, a method includes identifying at least one of: (i) a nuclear waste facility, located on a parcel of real property, that stores a nuclear waste material, or (ii) a nuclear power plant, located on the parcel, that produces the nuclear waste material; and constructing a borehole repository at the parcel of real property to form a hazardous waste repository system. The borehole repository includes at least one human-unoccupiable borehole formed from a terranean surface into a subterranean formation suitable to store hazardous waste. The at least one borehole includes an entry on the parcel of real property at the terranean surface and at least one human-unoccupiable storage region configured to store one or more hazardous waste canisters that enclose portions of a nuclear waste material.

In an aspect combinable with the second example implementation, the at least one human-unoccupiable borehole includes a directional borehole, a vertical borehole, a slant borehole, or a combination thereof.

In another aspect combinable with any of the previous aspects of the second example implementation, the subterranean formation is at a depth below the terranean surface unsuitable for human occupation.

In another aspect combinable with any of the previous aspects of the second example implementation, the nuclear waste material includes remote handled nuclear waste.

In another aspect combinable with any of the previous aspects of the second example implementation, the nuclear waste material includes contact handled nuclear waste.

In another aspect combinable with any of the previous aspects of the second example implementation, the nuclear waste material includes remote handled nuclear waste.

In another aspect combinable with any of the previous aspects of the second example implementation, the nuclear waste material includes spent nuclear fuel.

In another aspect combinable with any of the previous aspects of the second example implementation, the subterranean formation includes salt, shale, sedimentary, igneous, or metamorphic rock.

In another aspect combinable with any of the previous aspects of the second example implementation, the at least one borehole includes a casing that lines at least a portion thereof.

In another aspect combinable with any of the previous aspects of the second example implementation, the at least one borehole includes a first borehole portion that includes a first portion of the human-unoccupiable storage region formed in the first subterranean formation; and a second borehole portion that includes a second portion of the human-unoccupiable storage region formed in a second subterranean formation.

In another aspect combinable with any of the previous aspects of the second example implementation, at least one of the first or second borehole portions is a horizontal borehole portion.

In another aspect combinable with any of the previous aspects of the second example implementation, the at least one borehole includes a seal positioned between the terranean surface and the human-unoccupiable storage region.

In another aspect combinable with any of the previous aspects of the second example implementation, the identifying at least one of (i) or (ii) includes identifying both (i) and (ii).

In a third example implementation, a hazardous waste repository system includes a borehole sub-repository that includes at least one human-unoccupiable borehole formed from a terranean surface into a first subterranean formation suitable to store hazardous waste, where the at least one borehole includes an entry at the terranean surface and at least one human-unoccupiable storage region configured to store one or more hazardous waste canisters that enclose portions of a first hazardous waste material. The system includes a mined sub-repository that includes at least one human-occupiable tunnel formed from a shaft that extends from the terranean surface into a second subterranean formation suitable to store hazardous waste. The at least one tunnel includes a human-occupiable storage region configured to store one or more hazardous waste containers that enclose portions of a second hazardous waste material.

In an aspect combinable with the third example implementation, the at least one human-unoccupiable borehole includes a first entry at the terranean surface, and the shaft includes a second entry at the terranean surface different than the first entry.

In another aspect combinable with any of the previous aspects of the third example implementation, the first and second entries are co-located on a parcel of real property.

Another aspect combinable with any of the previous aspects of the third example implementation further includes a nuclear power facility located on the parcel of real property.

In another aspect combinable with any of the previous aspects of the third example implementation, the at least one human-unoccupiable borehole includes a directional borehole, a vertical borehole, a slant borehole, or a combination thereof.

In another aspect combinable with any of the previous aspects of the third example implementation, the first subterranean formation is at a first depth below the terranean surface unsuitable for human occupation.

In another aspect combinable with any of the previous aspects of the third example implementation, the second subterranean formation is at a second depth below the terranean surface suitable for human occupation.

In another aspect combinable with any of the previous aspects of the third example implementation, the first hazardous waste material includes remote handled nuclear waste.

In another aspect combinable with any of the previous aspects of the third example implementation, the second hazardous waste material includes contact handled nuclear waste.

In another aspect combinable with any of the previous aspects of the third example implementation, the first subterranean formation includes salt or shale.

In another aspect combinable with any of the previous aspects of the third example implementation, the second subterranean formation includes salt.

In another aspect combinable with any of the previous aspects of the third example implementation, the at least one borehole includes a casing that lines at least a portion thereof.

In another aspect combinable with any of the previous aspects of the third example implementation, the at least one borehole includes a first borehole portion that includes a first portion of the human-unoccupiable storage region formed in the first subterranean formation; and a second borehole portion that includes a second portion of the human-unoccupiable storage region formed in the second subterranean formation.

In another aspect combinable with any of the previous aspects of the third example implementation, at least one of the first or second borehole portions is a directional borehole portion.

In another aspect combinable with any of the previous aspects of the third example implementation, the at least one borehole includes a seal positioned between the terranean surface and the human-unoccupiable storage region.

In a fourth example implementation, a method includes identifying a mined sub-repository that is located on a parcel of real property on a terranean surface. The mined sub-repository includes at least one human-occupiable tunnel formed from a shaft that extends from the terranean surface into a first subterranean formation suitable to store hazardous waste, with the at least one tunnel including a human-occupiable storage region configured to store one or more hazardous waste containers that enclose portions of a first hazardous waste material. The method includes constructing a borehole sub-repository at the parcel of real property to form a hazardous waste repository system that includes the mined sub-repository and the borehole sub-repository. The borehole sub-repository includes at least one human-unoccupiable borehole formed from the terranean surface into a second subterranean formation suitable to store hazardous waste. The at least one borehole includes an entry at the terranean surface and at least one human-unoccupiable storage region configured to store one or more hazardous waste canisters that enclose portions of a second hazardous waste material.

In an aspect combinable with the fourth example implementation, the shaft includes a first entry at the terranean surface, and the at least one human-unoccupiable borehole includes a second entry at the terranean surface different than the first entry.

In another aspect combinable with any of the previous aspects of the fourth example implementation, the first and second entries are co-located on the parcel of real property.

Another aspect combinable with any of the previous aspects of the fourth example implementation further includes a nuclear power facility located on the parcel of real property.

In another aspect combinable with any of the previous aspects of the fourth example implementation, the at least one human-unoccupiable borehole includes a directional borehole, a vertical borehole, a slant borehole, or a combination thereof.

In another aspect combinable with any of the previous aspects of the fourth example implementation, the first subterranean formation is at a first depth below the terranean surface suitable for human occupation.

In another aspect combinable with any of the previous aspects of the fourth example implementation, the second subterranean formation is at a second depth below the terranean surface unsuitable for human occupation.

In another aspect combinable with any of the previous aspects of the fourth example implementation, the first hazardous waste material includes contact handled nuclear waste.

In another aspect combinable with any of the previous aspects of the fourth example implementation, the second hazardous waste material includes remote handled nuclear waste.

In another aspect combinable with any of the previous aspects of the fourth example implementation, the second subterranean formation includes salt or shale.

In another aspect combinable with any of the previous aspects of the fourth example implementation, the first subterranean formation includes salt.

In another aspect combinable with any of the previous aspects of the fourth example implementation, the at least one borehole includes a casing that lines at least a portion thereof.

In another aspect combinable with any of the previous aspects of the fourth example implementation, the at least one borehole includes a first borehole portion that includes a first portion of the human-unoccupiable storage region formed in the second subterranean formation; and a second borehole portion that includes a second portion of the human-unoccupiable storage region formed in the first subterranean formation.

In another aspect combinable with any of the previous aspects of the fourth example implementation, at least one of the first or second borehole portions is a directional borehole portion.

In another aspect combinable with any of the previous aspects of the fourth example implementation, the at least one borehole includes a seal positioned between the terranean surface and the human-unoccupiable storage region.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous waste repository according to the present disclosure.

FIGS. 2A and 2B are schematic illustrations of another example implementation of a hazardous waste repository according to the present disclosure.

### DETAILED DESCRIPTION

Hazardous waste, such as radioactive waste, chemical waste, biologic waste, or other waste that is generally harmful to living creatures whether directly or indirectly, can be stored underground. As an example, radioactive waste (also referred to as nuclear waste) can be stored in deep, human-unoccupiable drillholes (e.g., also called boreholes or wellbores) that are formed from a terranean surface into one or more subterranean formations that are suitable to store such waste for years, decades, centuries, or longer. In the present disclosure, the term “storage” includes the concept of “disposal” where disposal means storage for an indefinite time, with no intention to retrieve. For instance, the human-unoccupiable drillholes can be directional drillholes formed with conventional drilling equipment and include vertical, curved, and horizontal portions (including multilaterals in some cases). Alternatively, the human-unoccupiable drillholes can be substantially vertical or slanted (e.g., formed offset from substantially vertical).

However, no commercial nuclear waste has yet to be disposed anywhere in the world. This is a surprising fact, given that the U.S. facility for disposal (Yucca Mountain) was planned to be open in 1998, and that over 70,000 tons of such waste are now in temporary storage awaiting disposal. One cause of the problem is community opposition. Except in a few locations (e.g., Finland, where the community supports disposal in an underground, human-occupiable tunnel, called a “mined repository”). Most people in most countries are believed to want the waste disposed far away from their locality. This is often referred to as the “Not in my backyard,” or “NIMBY,” syndrome. The state of Nevada, for example, strongly opposed the site at Yucca Mountain that the U.S. Department of Energy had approved, and that is why there is no foreseeable solution to the nuclear waste problem. For example, currently all the spent nuclear fuel (SNF) in the United States sits on the surface or near surface at existing or former nuclear power plants, waiting for a solution.

And there is yet another problem. Although many technical experts have concluded that SNF can be transported safely on trucks and rail, the public has remained very skeptical. In particular, large regions controlled by indigenous peoples have refused to allow SNF to be moved over the roads or in railcars over their reservations. But the problem is deeper. Studies have shown that many people in states across the U.S. object strongly to transportation on their local roads.

Example implementations according to the present disclosure provide a hazardous waste repository that is proximate to one or both of above ground (or nearly above ground) nuclear waste storage facilities or nuclear power plants, thereby solving the NIMBY and transportation problems described herein.

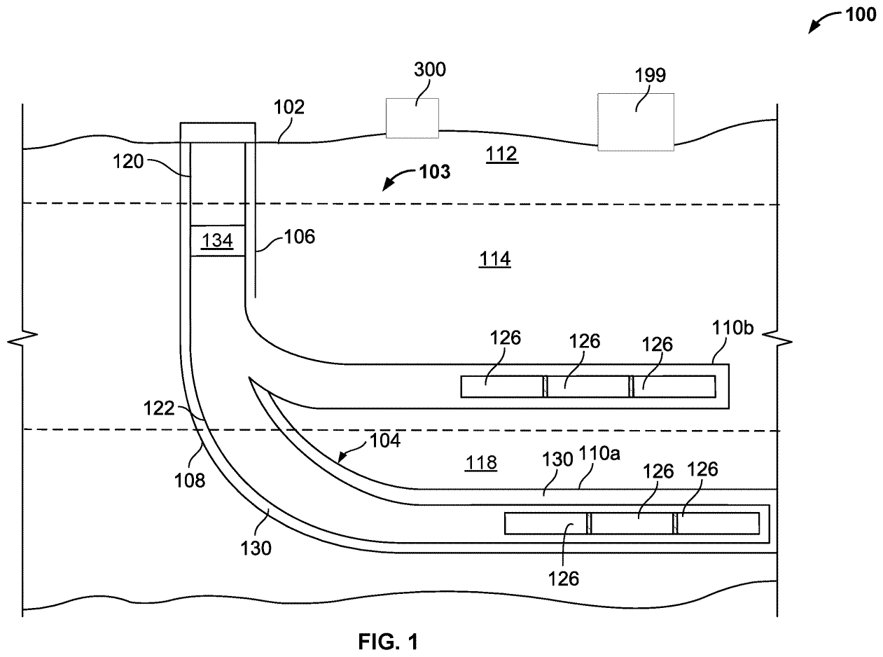

FIG. 1 shows an example implementation of a hazardous waste repository system 100 according to the present disclosure. FIG. 1 is not to scale and shows the hazardous waste repository system 100 that includes a borehole repository 103 co-located (e.g., proximate to) one or both of a nuclear waste storage facility 300 or a nuclear power plant 199. In some aspects, the borehole repository 103 and the nuclear waste storage facility 300 and/or a nuclear power plant 199 are located under and/or accessed from a single real property “parcel.” Here, “parcel” can mean an undivided area of real property owned by a single (or multiple) owner(s). “Parcel” can also mean two or more areas of real property (owned by a single or multiple owners) that are legally divided but adjacent (or nearly adjacent, such as in close proximity).

As shown in this example, the borehole repository 103 includes at least one human-unoccupiable drillhole 104 (or borehole 104) that is formed from a terranean surface 102, through a surface formation 112 (which can include, in some aspects, potable or mobile water), through an intermediate formation 114 (which can be of a suitable geology for borehole disposal of nuclear waste), and into a disposal formation 118 (which can be too deep to permit a human-occupiable tunnel of a mined-repository but of a suitable geology for borehole disposal of nuclear waste). Although shown as a directional drillhole 104 with a vertical portion 106 (e.g., an access portion that is substantially vertical), a curved portion 108, and a horizontal portion 110a, the drillhole 104 can also be implemented as a substantially vertical drillhole or a slanted drillhole (or multiple drillhole 104 can be implemented as a combination of such example orientations). In this example, a second lateral 110b is formed from the access portion 106 into the intermediate formation 114, while the horizontal portion 110a, which is formed into the disposal formation 118. Other laterals 110b (or no laterals 110b) can be included in alternative implementations. In both the horizontal portion 110a and lateral 110b, hazardous waste, such as nuclear waste (e.g., high, low, and/or medium level waste) can be enclosed in one or more hazardous waste canisters 126. In this example, at least a portion of the drillhole 104 can include a casing 122 that is secured within the drillhole 104 by cement 130. In other implementations, the drillhole 104 can be open-hole.

In some aspects, one or both of the formations 114 and 118 can be clay, shale, or salt (or sedimentary, igneous, or metamorphic rock). Other rock formations are also contemplated by the present disclosure. After emplacement of the canisters 126, a seal 134 (e.g., plug, packer, or other seal, removable or not) can be installed in the access portion 110 (or other locations to prevent migration of leaked waste to the terranean surface 102 through the drillhole 104). Examples of nuclear waste stored in the canister 126 can include one or more of spent nuclear fuel, TRU waste, remote handled waste, contact handled waste, vitrified waste, low level waste comprised of deconstructed reactor parts, radioactive liquid, or other waste.

Given the example implementation of FIG. 1, two additional facts, not widely known even to those practiced in the art of nuclear waste disposal, are these. First, if disposal is done sufficiently deep, then the possible leakage to the human-habitable environment (the “biosphere”) can be brought to extremely low levels. Such levels can be less than those required by existing or expected regulation, and far below the expose levels that humans get from other sources (such as ordinary cosmic rays, radiation from surface rocks, or medical examinations). Put simply, in some aspects, there is safety in depth. This fact means that virtually all currently surface stored waste can be safely disposed at or near the site where it is currently held in temporary or “interim” storage (such as facility 300 or even directly from nuclear power plant 199). The waste need not be transported over large distances. Moreover, careful and detailed simulations have shown that even the presence of large earthquake faults does not compromise the safety obtained by deep boreholes. In addition, measurements of isotopes as a function of depth can be used at many proximate sites to given to the regulators and the public and other stakeholders direct evidence that the deep, borehole disposal offers safety and isolation for very long periods of time.

People in states that currently hold nuclear waste in above ground interim sites prefer it to be buried at or near the current locations, rather than have it moved out by truck or rail. This fact is not widely known, even by those practiced in the field of nuclear waste disposal. The local population is more concerned with transportation accidents than with release from deep. This important insight has been verified by a study of people in 23 states that have commercial nuclear waste in temporary storage within their state. However, they do oppose waste being brought into their state from the outside, for the same reason. The old adage, “Not in my backyard” (NIMBY) does not describe the situation for high-level nuclear waste. Closer to the truth is “No transportation across my backyard.”

The borehole repository 103 of FIG. 1 provides for a very deep disposal solution, which can be achieved by drilling deep boreholes (such as borehole 104) at or near the current interim nuclear waste storage facilities 300 (and/or nuclear power plant 199). By drilling sufficiently deep, e.g., 1 to 2 km, geological formations 114 and 118 are reached from which transport to the surface 102 by diffusion or by advective transport is sufficiently small that the nuclear waste undergoes radioactive decay before it can reach the biosphere. A careful study of people in the 23 nuclear states in the U.S. has revealed that such a solution is highly desirable, provided that no external nuclear waste be brought in from other states. (This reflects the problem that the U.S. Department of Energy had in Nevada, in which all of the nuclear waste for the Yucca Mountain disposal site was to be transported in from distant locations.) In summary, the virtually intractable problem of long-term disposal of nuclear waste can be solved by having multiple, modular disposal facilities located at or near the current interim storage sites. The example implementation of FIG. 1 can provide for local placement of borehole disposal to solve the problem of strong opposition to the movement of such waste. Doing that provides a solution to the widely believed “not in my backyard” limitation that many experts felt would be the most difficult to solve.

Methods for constructing and/or operating the hazardous waste repository 100 shown in FIG. 1 can include one or more of the following steps. For example, the nuclear waste storage facility 300 and/or a nuclear power plant 199 can be located under and/or accessed from the parcel and may be existing facilities (or an existing facility) when initiation of the construction of the borehole repository 103 begins. Thus, in some aspects, the borehole repository 103 is constructed by forming the vertical portion 106 on the same parcel of land (or an adjacent or near parcel) on which the nuclear waste storage facility 300 and/or a nuclear power plant 199 is located.

Construction of the borehole repository 103 can then include completing the borehole 104 (which can be a vertical borehole, slant borehole, directional borehole, or combination thereof). In some aspects, the subterranean formation(s) 114 and/or 118 into which the borehole 104 is formed is at a depth below the terranean surface 102 that is unsuitable for human occupation. Thus, in some aspects, nuclear waste stored in the borehole 104 can be remote handled nuclear waste, contact handled nuclear waste, or both (such as spent nuclear fuel). Once the nuclear or other hazardous waste is emplaced, the seal 134 can be installed in the borehole 104 (e.g., in the vertical portion 106) to isolate the hazardous waste in canisters 126 from the terranean surface 102.

As described herein, hazardous (e.g., nuclear) waste can be disposed of in a “mined repository,” i.e., underground, human-occupiable tunnels in which, when the tunnel entrance is sealed, the waste is sufficiently isolated from the human environment that its likelihood of causing harm to any human is less than or equal to the stringent limits set by waste regulatory agencies. The tunnels are large enough to allow a human to enter. Typically, a mined repository also has ventilation shafts to supply air to humans working underground. The only mined repository of this kind that is currently being used to dispose of nuclear waste is the WIPP (Waste Isolation Pilot Plant) in New Mexico, although others are under construction in Finland and Sweden. The Yucca Mountain facility in Nevada is an example of a partially completed mined repository, although construction has been halted.

Many of these countries, particularly those with large inventories of waste (the U.S. has over 70,000 metric tons of spent nuclear fuel in temporary “interim” storage) have considered or dismissed alternatives to mined repositories, such as placing the waste in human-unoccupiable boreholes. One of the reasons that is given for the choice of a mined repository is that a mined repository offers the possibility of disposing of both high level waste (which is typically in small pieces, such as spent nuclear fuel pellets) as well as medium and low level waste (such as parts from dismantled nuclear reactors).

Thus, those who make decisions on disposal of nuclear waste assume that there are two competing methods, a mined repository and a borehole repository, and that a singular choice must be made between these competing methods. Additional assumptions have been made, such as that the geological assessment required for a borehole disposal would add substantially to the cost of borehole repositories above that of the mined repository. Even engineers practiced in the field of nuclear waste think that deciding to use borehole disposal implies that their work (sometimes spread over decades) was wasted, and to decide to use boreholes means, basically, to “start over.”

Thus, further example implementations according to the present disclosure include systems and methods for the construction and operation of an underground hazardous waste repository system that includes a mined sub-repository in combination with a borehole sub-repository. Such implementations provide an optimum solution for a hazardous waste problem, such as a nuclear waste problem, by combining a mined repository and a borehole repository, thus showing that there is not a binary choice between the mined solution and the borehole solution.

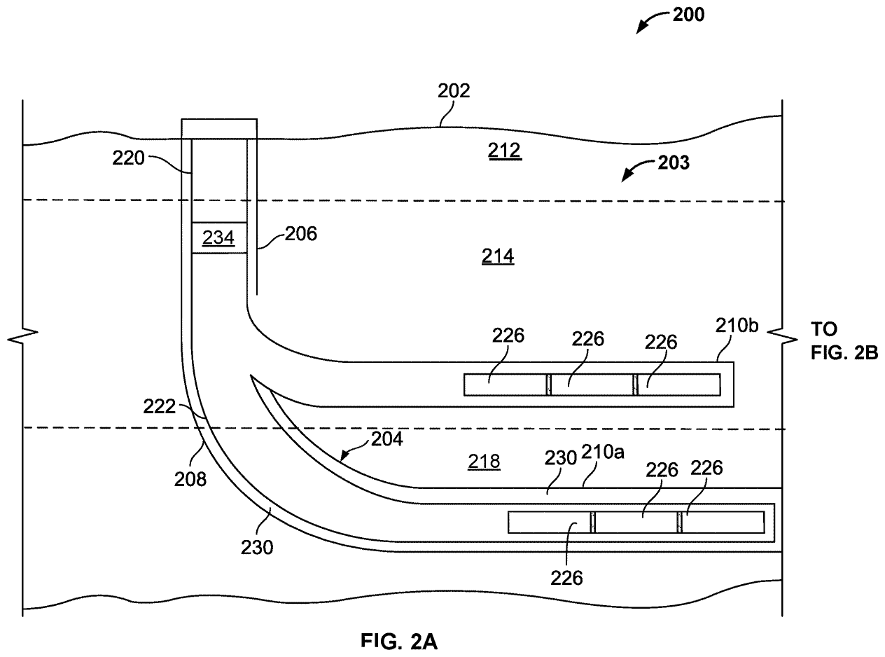

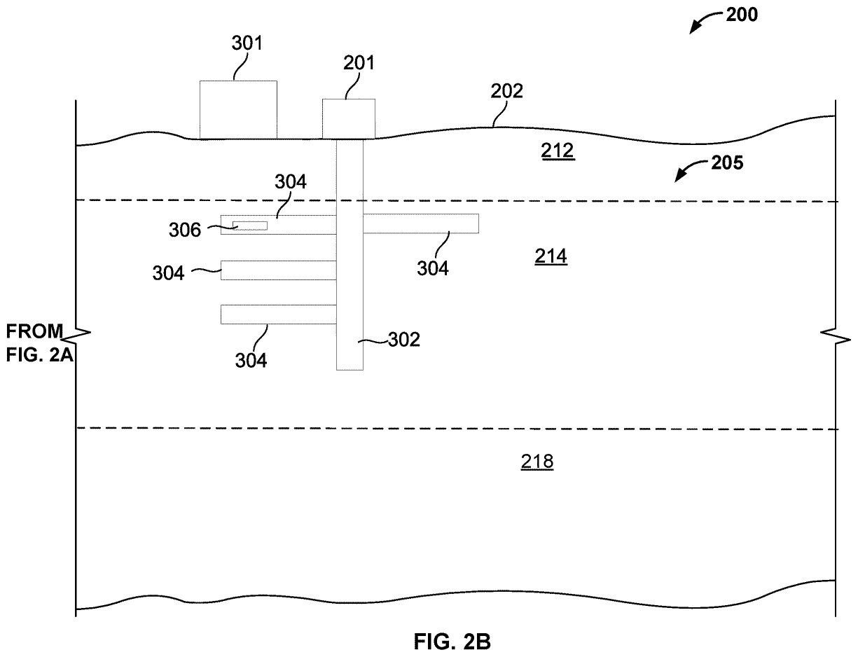

FIGS. 2A and 2B combine to show an example implementation of a hazardous waste repository system 200 according to the present disclosure. FIGS. 2A and 2B are not to scale and show the hazardous waste repository system 200 that includes a borehole sub-repository 203 in FIG. 2A with a mined sub-repository 205 in FIG. 2B. In some aspects, the borehole sub-repository 203 and the mined sub-repository 205 are located under and/or accessed from a single real property “parcel.” Again, in the present disclosure, “parcel” can mean an undivided area of real property owned by a single (or multiple) owner(s). “Parcel” can also mean two or more areas of real property (owned by a single or multiple owners) that are legally divided but adjacent (or nearly adjacent, such as in close proximity). In some aspects, a nuclear power facility 301 (e.g., a commercial nuclear power plant that generates spent nuclear fuel) can be co-located on the same parcel as the hazardous waste repository system 200.

As shown in this example, the borehole sub-repository 203 includes at least one human-unoccupiable drillhole 204 (or borehole 204) that is formed from a terranean surface 202, through a surface formation 212 (which can include, in some aspects, potable or mobile water), through an intermediate formation 214 (which can be shallow enough to permit a human-occupiable tunnel as shown in FIG. 2B but also of a suitable geology for borehole disposal of nuclear waste), and into a disposal formation 218 (which can be too deep to permit a human-occupiable tunnel as shown in FIG. 2B but of a suitable geology for borehole disposal of nuclear waste). Although shown as a directional drillhole 204 with a vertical portion 206 (e.g., an access portion that is substantially vertical), a curved portion 208, and a horizontal portion 210a, the drillhole 204 can also be implemented as a substantially vertical drillhole or a slanted drillhole (or multiple drillhole 204 can be implemented as a combination of such example orientations).

In this example, a second lateral 210b is formed from the access portion 206 into the intermediate formation 214, while the horizontal portion 210a, which is formed into the disposal formation 218. Other laterals 210b (or no laterals 210b) can be included in alternative implementations. In both the horizontal portion 210a and lateral 210b, hazardous waste, such as nuclear waste (e.g., high, low, and/or medium level waste) can be enclosed in one or more hazardous waste canisters 226. In this example, at least a portion of the drillhole 204 can include a casing 222 that is secured within the drillhole 204 by cement 230. In other implementations, the drillhole 204 can be open-hole. In some aspects, one or both of the formations 214 and 218 can be clay, shale, crystalline basement rock, or salt. Other rock formations are also contemplated by the present disclosure. After emplacement of the canisters 226, a seal 234 (e.g., plug, packer, or other seal, removable or not) can be installed in the access portion 210 (or other locations to prevent migration of leaked waste to the terranean surface 202 through the drillhole 204).

As illustrated in FIG. 2B, the mined sub-repository 205 can include a repository facility 201 in which hazardous waste, such as nuclear waste (e.g., high, low, and/or medium level waste) can be prepared for storage as waste 306 (in containers or not) in one or more human-occupiable tunnels 304. A shaft 302 can provide human access (and material and equipment access) from the facility 201 to the tunnels 304. As shown in this example, the shaft 302 and tunnels 304 are confined to the intermediate formation 214 due to its accessible depth. Other sub-systems of the mined sub-repository 205, such as electrical and ventilation, are not shown for simplicity.

A conventional example of a mined repository (such as the mined sub-repository 205) is the WIPP (Waste Isolation Pilot Plant) facility in Arizona, which disposes of transuranic defense nuclear waste. It is a mined repository in a salt formation. WIPP waste, generally, comes in two forms, called respectively RH-TRU waste and CH-TRU waste. In these acronyms, RH stands for “remotely handled,” CH for “contact handled,” and TRU for “transuranic waste,” which refers to radioactive elements beyond uranium on the periodic table.

CH waste consists of waste in which the bulk of the radioactivity consists of alpha particle and beta particles. For such waste, although the radioactivity produces heat, very few of these particles will penetrate the metal containers that hold the waste. The biggest danger comes from the few gamma rays and neutrons that do penetrate, but if those levels are sufficiently low, then humans can work in close-proximity, and that fact allows for a convenient and rapid handing of the waste packages.

In current operations at WIPP, most of the disposed containers are contact handled. But when there are enough RH containers to justify the expense of severely restricting all other operations at WIPP, then the WIPP facility is virtually closed except for the team and its specialized equipment that allows for the disposal of the RH waste. Once the RH waste has been sealed in the salt formation (e.g., intermediate formation 214 in the example implementation), typically behind several meters of salt, the facility is again opened for disposal of the less dangerous CH waste.

The virtual shutdown of WIPP during disposal of the RH waste is costly, and can be minimized if the RH waste is disposed of elsewhere. By using the borehole sub-repository 203, for instance, the RH waste can be disposed on the WIPP site in a proximate region that is within the site boundary but in which borehole disposal will not intersect the tunnels 304 of the mined sub-repository 205 (or regions where future tunnels 304 will be completed), such as in non-intersecting areas of intermediate formation 214, or in the deeper, human-inaccessible disposal formation 218.

Similar examples exist worldwide. There are numerous sites in which the waste can be divided into two parts. Small pieces of waste that can be disposed in boreholes will be dispose of in that way. Larger pieces that will not fit within boreholes can be disposed in the mined repository. Thus, the example implementation of the hazardous waste repository system 200 is particularly valuable where a mined repository have progressed far, and there is a fiduciary argument that much of the investment has already been spent. But even in these cases, the example implementation of the hazardous waste repository system 200 can save substantial cost, particularly when the mined tunnels are not yet completed to the extent whereby, they would hold all future waste.

A substantial advantage of example implementation of the hazardous waste repository system 200 is that the borehole(s) (e.g., drillhole 204) can either (a) be drilled in the same geologic formation as used by the mined repository (for example, as can be done at WIPP) where extensive geologic investigation has already shown the adequacy of the site for long-term disposal, or (b) can go much deeper. A deeper borehole is inherently much safer than a shallower one, since the mechanisms that transfer the radioactive atoms to the surface (diffusion and advection) take much longer to carry the particles the longer distance.

Methods for constructing and/or operating the hazardous waste repository 200 shown in FIGS. 2A-2B can include one or more of the following steps. For example, the mined sub-repository 205 can be located under and/or accessed from a parcel on the terranean surface 202 and may be an existing facility (or may be constructed) when initiation of the construction of the borehole repository 203 begins. Thus, in some aspects, the borehole repository 203 is constructed by forming the vertical portion 206 on the same parcel of land (or an adjacent or near parcel) on which the mined sub-repository 205 is located.

Construction of the borehole repository 203 can then include completing the borehole 204 (which can be a vertical borehole, slant borehole, directional borehole, or combination thereof, including a borehole with laterals 210a and 210b as shown). In some aspects, the subterranean formation 218 into which the borehole portion 210a is formed is at a depth below the terranean surface 202 that is unsuitable for human occupation (while subterranean formation 214 can be at a human-accessible depth). Thus, in some aspects, nuclear waste stored in the borehole portion 210a (as well as portion 210b) can be remote handled nuclear waste, contact handled nuclear waste, or both (such as spent nuclear fuel). Once the nuclear or other hazardous waste is emplaced, the seal 234 can be installed in the borehole 204 (e.g., in the vertical portion 206) to isolate the hazardous waste in canisters 226 from the terranean surface 202.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A hazardous waste repository system, comprising:
a borehole repository that comprises at least one human-unoccupiable borehole formed from a terranean surface into a subterranean formation suitable to store hazardous waste, the at least one borehole comprising an entry on a parcel of real property at the terranean surface and at least one human-unoccupiable storage region configured to store one or more hazardous waste canisters that enclose portions of a nuclear waste material; and
at least one of: (i) a nuclear waste facility, located on the parcel, that stores the nuclear waste material, or (ii) a nuclear power plant, located on the parcel, that produces the nuclear waste material.

2. The hazardous waste repository system of claim 1, wherein the at least one of (i) or (ii) comprises both (i) and (ii).

3. The hazardous waste repository system of claim 1, wherein the at least one human-unoccupiable borehole comprises a directional borehole, a vertical borehole, a slant borehole, or a combination thereof.

4. The hazardous waste repository system of claim 1, wherein the subterranean formation is at a depth below the terranean surface unsuitable for human occupation.

5. The hazardous waste repository system of claim 1, wherein the nuclear waste material comprises remote handled nuclear waste.

6. The hazardous waste repository system of claim 1, wherein the nuclear waste material comprises contact handled nuclear waste.

7. The hazardous waste repository system of claim 1, wherein the nuclear waste material comprises remote handled nuclear waste.

8. The hazardous waste repository system of claim 1, wherein the nuclear waste material comprises spent nuclear fuel.

9. The hazardous waste repository system of claim 1, wherein the subterranean formation comprises salt, shale, sedimentary, igneous, or metamorphic rock.

10. The hazardous waste repository system of claim 1, wherein the at least one borehole comprises a casing that lines at least a portion thereof.

11. The hazardous waste repository system of claim 1, wherein the at least one borehole comprises:
a first borehole portion that includes a first portion of the human-unoccupiable storage region formed in the first subterranean formation; and
a second borehole portion that includes a second portion of the human-unoccupiable storage region formed in a second subterranean formation.

12. The hazardous waste repository system of claim 11, wherein at least one of the first or second borehole portions is a horizontal borehole portion.

13. The hazardous waste repository system of claim 1, wherein the at least one borehole comprises a seal positioned between the terranean surface and the human-unoccupiable storage region.

14. A method, comprising:
identifying at least one of: (i) a nuclear waste facility, located on a parcel of real property, that stores a nuclear waste material, or (ii) a nuclear power plant, located on the parcel, that produces the nuclear waste material; and
constructing a borehole repository at the parcel of real property to form a hazardous waste repository system, the borehole repository comprising:
at least one human-unoccupiable borehole formed from a terranean surface into a subterranean formation suitable to store hazardous waste, the at least one borehole comprising an entry on the parcel of real property at the terranean surface and at least one human-unoccupiable storage region configured to store one or more hazardous waste canisters that enclose portions of a nuclear waste material.

15. The method of claim 14, wherein the at least one human-unoccupiable borehole comprises a directional borehole, a vertical borehole, a slant borehole, or a combination thereof.

16. The method of claim 14, wherein the subterranean formation is at a depth below the terranean surface unsuitable for human occupation.

17. The method of claim 14, wherein the nuclear waste material comprises remote handled nuclear waste.

18. The method of claim 14, wherein the nuclear waste material comprises contact handled nuclear waste.

19. The method of claim 14, wherein the nuclear waste material comprises remote handled nuclear waste.

20. The method of claim 14, wherein the nuclear waste material comprises spent nuclear fuel.

21. The method of claim 14, wherein the subterranean formation comprises salt, shale, sedimentary, igneous, or metamorphic rock.

22. The method of claim 14, wherein the at least one borehole comprises a casing that lines at least a portion thereof.

23. The method of claim 14, wherein the at least one borehole comprises:
a first borehole portion that includes a first portion of the human-unoccupiable storage region formed in the first subterranean formation; and
a second borehole portion that includes a second portion of the human-unoccupiable storage region formed in a second subterranean formation.

24. The method of claim 23, wherein at least one of the first or second borehole portions is a horizontal borehole portion.

25. The method of claim 14, wherein the at least one borehole comprises a seal positioned between the terranean surface and the human-unoccupiable storage region.

26. The method of claim 14, wherein the identifying at least one of (i) or (ii) comprises identifying both (i) and (ii).

27-56. (canceled)
